(19) United States
(12) Patent Application Publication
(10) Pub. No.: US 2023/0267380 A1
(43) Pub. Date: Aug. 24, 2023

(54) METHODS, SYSTEMS, AND COMPUTER READABLE MEDIA FOR MACHINE LEARNING OF MULTIPLE TASKS

(71) Applicant: The Trustees of the University of Pennsylvania, Philadelphia, PA (US)

(72) Inventors: Pratik Anil Chaudhari, Philadelphia, PA (US); Rahul Ramesh, Philadelphia, PA (US)

(21) Appl. No.: 18/112,763

(22) Filed: Feb. 22, 2023

Related U.S. Application Data
(60) Provisional application No. 63/312,726, filed on Feb. 22, 2022.

(51) Int. Cl. G06N 20/20

(52) U.S. Cl. CPC G06N 20/20

(57) ABSTRACT

Methods, systems, and computer readable media for machine learning of multiple tasks. In some examples, a method includes performing multiple rounds of training. For each training round, the method includes selecting a subset of computing tasks from the tasks being learned; building a feature generator for the subset of computing tasks; and training a task-specific classifier for each computing task, resulting in model for each computing task of the subset of computing tasks. The method can then include using the models for performing one of the computing tasks.

### CROSS-REFERENCE TO RELATED APPLICATIONS

This application claims benefit of U.S. Provisional Application Ser. No. 63/312,726, filed on Feb. 22, 2022, the disclosure of which is incorporated herein by reference in its entirety.

### TECHNICAL FIELD

This specification relates generally to machine learning and in particular to methods, systems, and computer readable media for learning multiple tasks.

### BACKGROUND

Leveraging data from multiple tasks, either all at once, or incrementally, to earn one model is an idea that lies at the heart of multi task and continual learning methods. Ideally, such a model predicts each task more accurately than if the task were trained in isolation.

### SUMMARY

This specification describes methods, systems, and computer readable media for machine learning of multiple tasks. In some examples, a method includes performing multiple rounds of training. For each training round, the method includes selecting a subset of computing tasks from the tasks being learned; building a feature generator for the subset of computing tasks; and training a task-specific classifier for each computing task, resulting in model for each computing task of the subset of computing tasks. The method can then include using the models for performing one of the computing tasks.

The subject matter described herein may be implemented in hardware, software, firmware, or any combination thereof. As such, the terms “function” or “node” as used herein refer to hardware, which may also include software and/or firmware components, for implementing the feature(s) being described. In some exemplary implementations, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF DRAWINGS

FIG. 1A is a block diagram of a computer system configured for machine learning of multiple tasks.

FIG. 1B shows, on the top, average per-task accuracy (%, mean+/−std. dev. across 5 bootstraps of data) for a few multi-task learning datasets. “Isolated” train each task in isolation; “Multi-Head” has a shared feature generator with task-specific classifiers. We find that (i) Multi-Head outperforms Isolated, so multi-task learning helps but improvements diminish with more samples. We should therefore also compare multi-task learning methods on fewer samples/class to get statistically significant conclusions. (ii) MNIST, Rotated-MNIST and Permuted-MNIST are poor benchmark datasets; even Isolated achieves 99%+ accuracy and training on any task is essentially as good as training on all tasks even at low sample sizes.

FIG. 1B shows, on the bottom, in order to demonstrate how some tasks help and some tasks hurt each other, we run Multi-Head for a varying number of tasks (X-axis) and track the accuracy on a few tasks from Coarse-CIFAR 100. Cells are colored warm if accuracy is worse than the median accuracy of that row. For instance, multi-task training with 11 tasks is beneficial for “Man-made Outdoor” but accuracy drops drastically upon introducing task #12, it improves upon introducing #14, while task #17 again lead to a drop. One may study the other rows to reach a similar conclusion: there is non-trivial competition between tasks, even in commonly used datasets. Tackling this effectively is useful in obtaining good performance on multi-task learning problems.

FIG. 1C further investigates task competition. Cells are colored by the gain (green)/loss (warm) of accuracy of pairwise Multi-Head training as compared to training the row-task in isolation; this is a good proxy for the transfer coefficient ρᵢⱼ. Although most pair benefit each other (green), certain tasks, e.g., “Food Container” are best trained in isolation while others such as “Aquatic Mammals” are typically detrimental to most other tasks. In essence, whether tasks aid or hurt each other is nuanced even for Coarse-CIFAR100.

FIG. 2 shows that, ideally, we want to train synergistic tasks together, e.g., Model 1 for P₁ using P₂, P₅, P₆ and Model 3 using P₆, P₅. At test time, all models (1, 2, 3) that were trained on a particular task say P₅ would make predictions. Model Zoo is a simple, scalable instantiation of this idea. Instead of explicitly selecting non-competing tasks which is difficult, it selects tasks that have high training loss under the current ensemble.

FIG. 3A is a table shows average per-task accuracy across 5 bootstraps of 100 samples/class each. FIG. 3B is a table shows average per-task accuracy with all samples. FIG. 3C is table shows average per-task accuracy (for clean tasks) across 5 bootstraps of 100 samples/class each for our created noisy multi-task learning problems.

FIG. 4A is table showing average per-task accuracy (%) for continual learning at the end of all episodes. MNIST, Permuted-MNIST and Rotated-MNIST are not informative benchmarks for judging forward and backward transfer because even Isolated achieves 99%+ accuracies. Model Zoo outperforms, by significant margins, all of these continual learning methods; in fact their accuracy is worse than Isolated which suggests little to no forward or backward transfer.

FIG. 4B is chart showing accuracy on a task as function of boosting rounds for Model Zoo-continual on Coarse-CIFER100. ‘X’ markers denote accuracy of Isolated on the new task. We see both forward transfer (Model Zoo often starts with a higher accuracy than Isolated) and backward transfer (accuracy of some past tasks improves in later episodes).

FIG. 5A is a table showing increasing tasks per boosting round does not always improve Model Zoo. FIG. 5B is a table showing that more rounds of boosting improve accuracy, do not show overfitting. FIG. 5C is a table that shows that Model Zoo performs better than ensembles of both Isolated and Multi-Head learners. One 100 samples/class bootstrap dataset was used.

FIG. 6 is a table that shows that using a larger model for Multi-Head does not outperform Model Zoo.

FIG. 7A is a chart illustrating how well existing continual learning methods work. We track the average accuracy (over all tasks seen until the current episode) on the Split-minilmagenet dataset and compare our method Model Zoo and its variants (all in bold) to existing continual learning methods. All methods in this plot (unless specified otherwise) use the single epoch setting, i.e., each new task is allowed only 1 epoch of training. Isolated refers to a very simplistic realization of Model Zoo where a separate model is fitted at each episode without any continual learning, or data sharing between tasks; Isolated-small or Model Zoo-small refer to using a very small deep network with 0.12M weights. A number of surprising findings are seen here. (i) Isolated-small (black) outperforms existing methods by more than 10% margin, while having a faster training time, inference time, comparable model size and without performing any data replay. This indicates that existing methods do not sufficiently leverage data from multiple tasks. This also indicates the utility of simple methods like Isolated to perform a more prosaic, matter-of-fact, evaluation of continual learning. (ii) While the larger model with 3.6M weights per round, Isolated-Single Epoch (royal blue), performs poorly, its accuracy is dramatically better than all existing methods (Isolated-Multi Epoch) upon being trained for multiple epochs. This indicates that existing methods may be severely under-trained in the single-epoch setting and this may not be the appropriate setting to build continual learning methods. (iii) Model Zoo and Model Zoo-small which replay all data from past tasks (A-GEM also replays 10% of the data), achieves around 10% improvement over its Isolated counterparts in both the single-epoch and multi-epoch setting; all these 4 methods advocated in this paper are dramatically better than existing algorithms. Even Model Zoo-single epoch which replays past data but trains on the new task only for 1 epoch outperforms existing methods significantly. This indicates that replaying data from past tasks is beneficial, even if replay may not conform to certain stylistic formulations of continual learning in the literature. Not doing so significantly hurts forward and backward transfer, and average task accuracy.

FIG. 7B is a chart illustrating whether the single-epoch setting shows forward-backward transfer. The evolution of individual task accuracy of Model Zoo (the multi-epoch setting in bold and single-epoch setting in dotted), on the Splitminilmagenet dataset (only 5 tasks are plotted here, see Fig. A6 for the full version). The X markers denote the accuracy of Isolated. Accuracy of tasks improves with each episode which indicates backward transfer. Also, the X markers are often below the initial accuracy of the task during continual learning, which indicates forward transfer. While both single-epoch and multi-epoch Model Zoo show good forward-backward transfer, the accuracy of tasks for the former is about 25% worse than the latter. This indicates that we should also pay attention to under-training and per-task accuracy in continual learning.

FIG. 8 is a chart illustrating that competition between tasks in continual learning can be non-trivial. In order to demonstrate how some tasks help and some tasks hurt each other, we run a multi-task learner for a varying number of tasks (X-axis) and track the accuracy on a few tasks from CIFAR100 (each task is a superclass). Each cell represents a different experiment, i.e., there is no continual learning being performed here. Cells are colored warm if accuracy is worse than the median accuracy of that row. For instance, multi-task training with 11 tasks is beneficial for “Man-made Outdoor” but accuracy drops drastically upon introducing task #12, it improves upon introducing #14, while task #17 again leads to a drop. One may study the other rows to reach a similar conclusion: there is non-trivial competition between tasks, even in commonly used datasets. As we show, tackling this effectively is the key to obtaining good performance on multi task learning problems.

FIG. 9 is a table that shows average per-task accuracy (%) at the end of all episodes. MNIST, Permuted-MNIST and Rotated-MNIST are not informative benchmarks for judging forward and backward transfer because even Isolated achieves 99%+ accuracy. Model Zoo outperforms, by significant margins, all existing continual learning methods on all datasets. Accuracy of existing methods is worse than Isolated which suggests little to no forward or backward transfer. Model Zoo-small and Isolated-have comparable number of weights as that of existing methods, and in some cases, much fewer.

FIG. 10 is a table that shows a comparison of continual learning evaluation metrics on Split-CIFAR100 for existing methods and the methods developed in this paper. Our methods demonstrate strong forward and backward transfer, high per-task accuracy, smaller training times and comparable inference times. Training times of other methods are from Chaudhry et al. (2019a) and it is the total training time in minutes for all tasks. The Inference time is the per sample prediction latency averaged over 50 mini-batches of size 16.

FIG. 11 shows ablation studies that show the average per-task accuracy as we vary the size of data replay for Model Zoo (left), the number of past tasks sampled at each episode (middle, [symbol] =1 implies no replay), and compare Model Zoo with an ensemble of Isolated models (right). These results are for the single-epoch setting. Accuracy is roughly the same on Split-CIFAR100 across varying degrees of replay while it improves significantly on Split-minilmagenet; this suggests that Model Zoo also works with very small amounts of data replay. Accuracy on Split-CIFAR100 is consistent as the number of replay tasks is changed but increases dramatically on larger datasets like Split-minilmagenet where there are many more tasks. Finally, the performance of Model Zoo is not merely an artifact of ensembling. Even if Isolated is a strong model, a very large ensemble of Isolated compares poorly to Model Zoo with 100% replay; this indicates that Model Zoo can effectively leverage data from past tasks without forgetting.

### DETAILED DESCRIPTION

This specification describes methods, systems, and computer readable media for machine learning of multiple tasks. In some examples, a method includes performing multiple rounds of training. For each training round, the method includes selecting a subset of computing tasks from the tasks being learned; building a feature generator for the subset of computing tasks; and training a task-specific classifier for each computing task, resulting in model for each computing task of the subset of computing tasks. The method can then include using the models for performing one of the computing tasks.

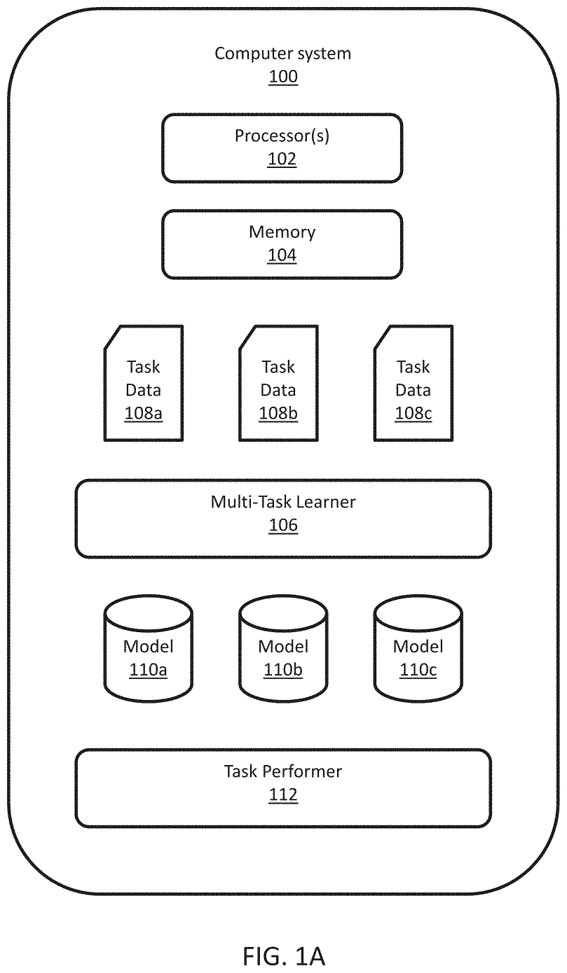

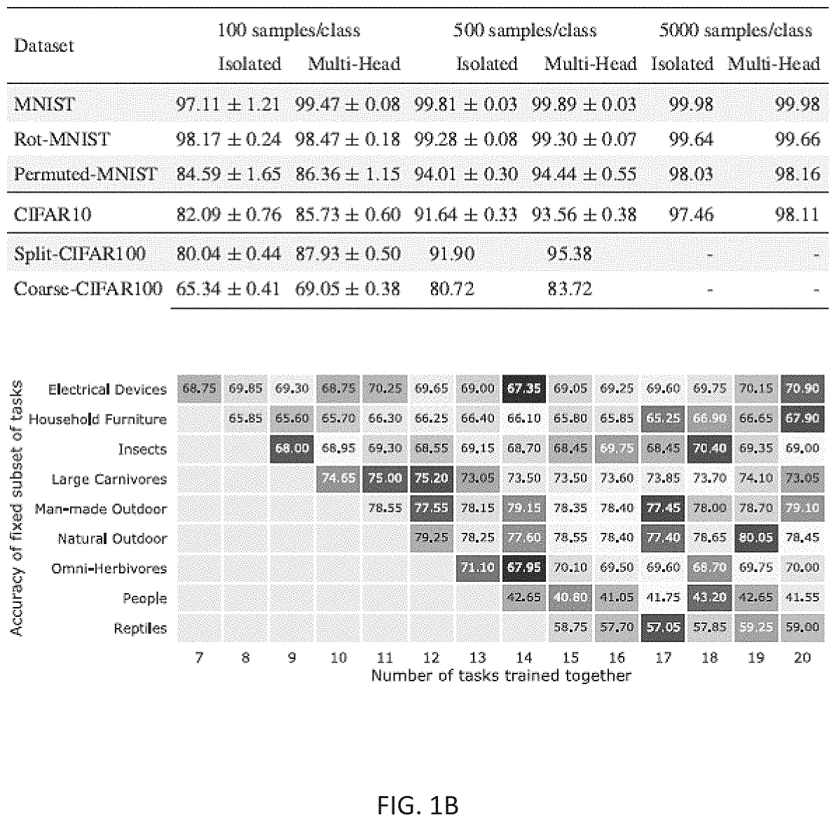

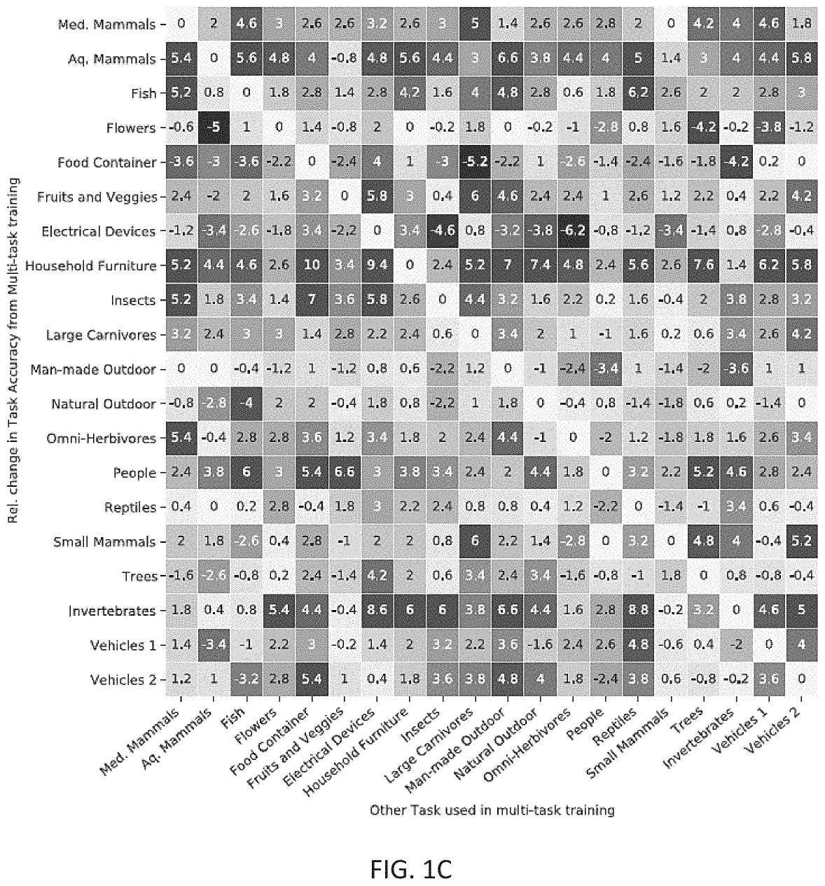

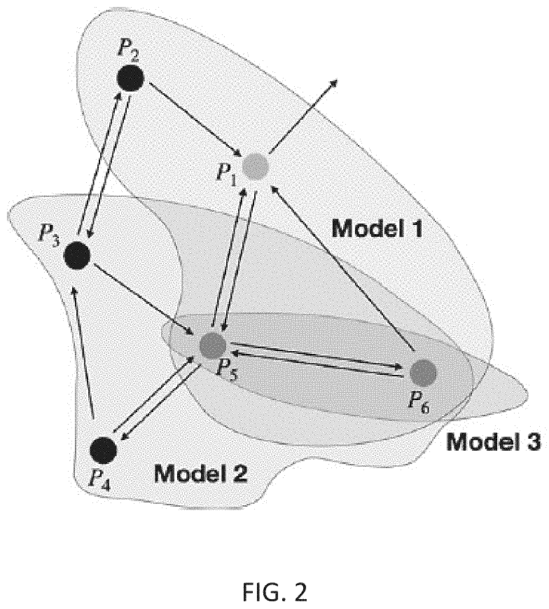

FIG. 1A is a block diagram of a computer system 100 configured for machine learning of multiple tasks. The computer system 100 includes one or more processors 102 and memory 104 storing executable instructions for the processors 102.

The computer system 100 includes a multi-task learner 106 configured for multi-task and continual learning. The multi-task learner 106 can use a boosting-based algorithm that iteratively grows an ensemble of models, each of which may be relatively small and is trained on a subset of a number of computing tasks. The multi-task learner 106 is configured to perform a number of training rounds.

For each training round, the multi-task learner 106 can be perform operations including: selecting a subset of computing tasks from a number of computing tasks; building a feature generator for the subset of computing tasks; and training, using task data 108a-c, a task-specific classifier for each computing task of the subset of computing tasks, resulting in models 110a-c for each computing task of the subset of computing tasks.

Selecting the subset of computing tasks can include maintaining a vector of task-specific weights and selecting the subset of computing tasks based on the task-specific weights. Selecting the subset of computing tasks based on the task-specific weights can include drawing the subset of computing tasks from a multinomial distribution of the task-specific weights.

The multi-task learner 106 can be configured for revisiting at least a first computing task from the plurality of computing tasks by adding one or more new models. The multi-task learner 106 can be further configured for maintaining one or more models from previous training rounds not updated in successive training rounds.

In some examples, each of the computing tasks shares a common input domain. The multi-task learner 106 can be configured for learning at least one task-specific adapter for at least one computing task having a different input domain from at least one other computing task.

The computer system 100 includes a task performer 112 configured for performing, using at least some of the models 110a-c, one or more of the computing tasks.

Examples of the methods, systems, and computer readable media for machine learning of multiple tasks are described below with reference to two papers, “Boosting a Model Zoo” and “Model Zoo: A Growing Brain that Learns Continuously.”

Boosting a Model Zoo

Introduction

“Your ability to juggle many tasks will take you far away”, reads the motivating quote from Rich Caruana's doctoral dissertation. Indeed, if we can effectively exploit data from multiple related tasks, we may be able to learn inductive biases that reduce the amount of data required from each task. If we can continually expand these inductive biases, we can avoid the tabula rasa learning that an artificial learner executes and take a step towards developing sample-efficient-human-like-learning abilities.

There are two key challenges in the above program. First, one shouldn't expect an unrelated task to be relevant to the learning of another task. It is difficult to know when tasks are relevant for learning each other. Second, tasks may not just be irrelevant but they may also compete with each other if they do not share salient features. This competition arises from the fixed learning capacity of the learner. It therefore stands to reason that any learner which seeks to continually learn from diverse tasks should have the ability to identify tasks that are synergistic, and grow its learning capacity to accommodate new tasks that may compete with previous ones. Our goal is to formalize this argument, and instantiate it to obtain new methods for multi-task and continual learning. Our contributions are:
(i) We formalize how some tasks can compete when trained together due to the fixed learning capacity of a model. We prove that training with (without) a particular task deteriorates (improves) the accuracy on a given task. We identify such competition in commonly used datasets.
(ii) We circumvent the above result and develop a new method for multi-task and continual learning. Model Zoo is a boosting-based algorithm that iteratively grows an ensemble of models, each of which is very small, and is trained on a subset of the tasks. At test time, Model Zoo makes predictions using models from all arounds were trained on a particular task.
(iii) We find that even if simple methods such a s training each task in isolation, or using a shared feature generator with task-specific methods such as training each task in isolation, or using a shared feature generator with task-specific classifiers, have been considered before, it has gone unnoticed that they outperform sophisticated state-of-the-art multi-task and continual learning algorithms, which do not in fact achieve strong forward or backward transfer. This is rather surprising and indicates that we should interpret empirical results in the current literature with a grain of salt.
(iv) To ameliorate the above issue, we propose new benchmarks constructed from the CIFAR-100 dataset. In these problems, tasks are related but exploiting these relationships requires more sophisticated methods for learning from multiple tasks.
(v) We perform a comprehensive evaluation of Model Zoo on image classification benchmarks, including the ones above of our creation. We find that it significantly outperforms all state-of-the-art multi-task and continual learning algorithms.

### Does Training Multiple Tasks Together Always Help?

The answer to this question is nuanced and depends on the relatedness between tasks. We first formulate the problem, then discuss a simple model to understand when training multiple tasks together helps, and provide new results where the fixed capacity of the learner causes competition between tasks, i.e., it performs poorly on a particular task due to the presence of other tasks.

### Problem Formulation

A supervised learning task is defined as a joint probability distribution P(x, y) of inputs x∈X and labels [symbol] ∈Y. The learner has access to m i.i.d samples S=(xᵢ, yᵢ)_{i=1, . . . ,m} from the task. A hypothesis is a function h:X→Y with h∈H being the hypothesis space. The learner may select a hypothesis that minimizes the empirical risk

$${\hat{e}}_{𝒮} ( h ) = \frac{1}{m} {\sum }_{i = 1}^{m} {1}_{\{ h ( {x}_{i} ) \neq {y}_{i} \}}$$

with the hope of achieving a small value of the population risk

e_{P}(h)= [symbol] (h(x)≠ [symbol] )

Classical PAC-learning results suggest that with probability at least 1−δ over draws of the data S, uniformly for any h∈H, we have eₚ(h)≤e̊_{S}(h)+ [symbol] if

m=O((D−log δ)/ [symbol] ²)

where D=VC(H) is the VC-dimension of the hypothesis space H and c is a constant. We define the “excess risk” of a hypothesis as

$${ℰ}_{P} ( h ) = {e}_{P} ( h ) - {inf}_{h ∈ H} {e}_{P} ( h )$$

In the multi-task setting, we have n tasks P̅:=(P₁, . . . , Pₙ) with corresponding training sets S̅:=(S₁, . . . , Sₙ), each with m samples and the learner selects n hypothesis h̅=(h₁, . . . , hₙ)∈Hⁿ, each hᵢ [symbol] H. It may seek to achieve a small value of the average population risk

$${e}_{\overline{P}} ( \overline{h} ) = \frac{1}{n} {\sum }_{i = 1}^{n} {e}_{{P}_{i}} ( {h}_{i} ) .$$

and may do so by minimizing the average empirical risk

$${\hat{e}}_{\overline{𝒮}} ( \overline{h} ) = \frac{1}{n} {\sum }_{i = 1}^{n} {\hat{e}}_{{𝒮}_{i}} ( {h}_{i} )$$

As Baxter shows, with probability at least 1−δ over draws of data, under very general conditions, for a large number of tasks, if the number of samples per task is

$$m = ( \frac{1}{{e}^{2}} ( {d}_{H} ( n ) - \frac{1}{n} log δ ) )$$

then we have e_{P}(h̅)≤e_{S}(h̅)+∈ for any h̅∈Hⁿ. The quantity d_{H}(n) here is a generalized VC-dimension for the family of hypothesis spaces Hⁿ, which also depends on the distribution over tasks. Large the number of tasks n, smaller d_{H}(n). Whether (2) is an improvement upon training the task in isolation as in (1) depends upon the hypothesis class H and the relatedness of tasks P₁, . . . , Pₙ through the quantity d_{H}(n). According to these calculations, if one wishes to obtain a small average population risk across tasks, training multiple tasks together cannot be worse:

d_{H}(n)≤D.

This result is the motivation for methods that train multiple tasks together.

### Controlling the Excess Risk of a Specific Task

The purpose of obtaining data from multiple tasks is often to do well on one, or all tasks. This is a stronger requirement than for (2) which bounds the average population risk on all tasks. We next discuss a simple setup to understand this.

Suppose there exists a family F of functions fᵢ:X→X that map inputs of one task to those of another, i.e., any task can be written as

Pⱼ(A)=f[Pᵢ](A)= [symbol] ({(f(x),y):(x,y) [symbol] A})

for some function ƒ∈F for any set A. We can assume without loss of generality that F acts as a group over the hypothesis space and H is closed under its action. In simple words, this entails that given h∈H suitable for task P, we can obtain a new hypothesis h∘f that is suitable for another task f[P]. Instead of searching over the entire space Hⁿ, we now only need to find a hypothesis h∈H such that its orbit

[h]_{F}={h′:∃ƒ∈F with h′=h∘ƒ}

contains hypotheses that have low empirical risk on each of the n tasks. Conceptually, this step learns the inductive bias. The sample complexity of doing so is exactly (2). From within this orbit, we can select a hypothesis that has low empirical risk for a chosen task P₁. The sample complexity of this second step is

|S₁|= [symbol] (∈⁻²(dₘₐₓ−log δ))

where dₘₐₓ=sup_{hϵH} VC([h]_{f}). By uniform convergence, as Ben-David and Schuller show, this two-step procedure assures low excess risk for every task P₁, . . . Pₙ. We have

$${sup}_{h ∈ H} VC ( {[ h ]}_{F} ) = {d}_{max} \leq {d}_{H} ( n + 1 ) \leq {d}_{H} ( n ) \leq D = VC ( H )$$

The total sample complexity is favorable to that of learning the task in isolation if both d_{H}(n) and dₘₐₓ are small. For instance, if F is finite and n/log n≥D, we have d_{H}(n)≤log|F| which indicates that we get a statistical benefit of learning with multiple tasks if D>>log|F|. Let us make a few useful observations. (i) From (4), number of samples per task m decreases with n; this is a direct benefit of the strong relatedness amongst the tasks and as we see next, this is not the case in general. (ii) The number of tasks scales essentially linearly with D, which indicates that one should use a small model if we have few tasks. (iii) But we cannot always use a small model. If tasks are diverse and related by complex transformations with a large |F|, we need a large hypothesis space to learn them together. If |F| is large and H is not appropriately so, the VC-dimension dₘₐₓ is as large as D itself; in this case there is again non statistical benefit of training with multiple tasks. One can calculate d_{H}(n) for many other tasks and the conclusions, in particular for non-finite F, are similar.

The tasks above are strongly related to each other the orbit [h*₁]_{F} of the optimal hypothesis for task P₁ contains optimal hypotheses for all other tasks. There can be inefficiencies while learning multiple tasks together in this case, but we always get better excess risk and there is no competition.

Task Competition Occurs for Hypothesis Spaces with Limited Capacity

We consider a weaker notion of relatedness. We say that two tasks Pᵢ, Pⱼ are pᵢⱼ-related if

cε_{P}_{ᵢ}^{1/p}^{ᵢⱼ}(h)≥ε_{P}_{ⱼ}(h,h*ᵢ), for all h∈H.

Here ε_{P}(h,h′):=e_{P}(h)−e_{P}(h′), h*ᵢ=argmin_{h∈H}e_{P}_{ᵢ}(h) is the best hypothesis for task Pᵢ and c≥1 is a coefficient independent of i, j. Smaller the pᵢⱼ, more useful the samples from Pᵢ to learn Pⱼ.
The definition suggests that all hypothesis h which have low excess risk on Pᵢ also have low excess risk on Pⱼ up to an additive term eₚⱼ (h*) and this effect becomes strong as pij→1+. Haneke and Kpotufe call this the transfer exponent. It is also similar to the assumption of a triangle inequality between the tasks: in the realizable setting where eₚᵢ(h*ᵢ)=0, for c,pᵢⱼ=1, we can write (5) as

e_{P}_{ᵢ}(h)+e_{P}_{ⱼ}(h*ᵢ)≥e_{P}_{ⱼ}(h)

The following theorem bounds the excess risk E_{P1} (h) for a hypothesis h using data from multiple tasks.
Theorem 1 (Task competition). Suppose we wish to find a good hypothesis for task P₁ and have access to n tasks P₁, . . . , Pₙ where each pair Pᵢ, Pⱼ are pij-related. Arrange tasks in increasing order of pᵢ₁, i.e., their relatedness to P₁. Let this ordering be P₍₁₎, P₍₂₎, . . . , P₍ₙ₎, with p₍₁₎≤p₍₂₎≤ . . . ≤p₍ₙ₎ and P₍₁₎=P₁ and p₍₁₎=1. Let ĥ^{k} the hypothesis that minimizes the average empirical risk of the first k≤n tasks. Then, with probability at least 1−δ over draws of the samples,

$${ℰ}_{{P}_{1}} ( {\hat{h}}^{k} ) \leq \frac{c}{k} {\sum }_{i = 1}^{k} {\hat{e}}_{{𝒮}_{i}} ( {\hat{h}}^{k} ) + \frac{c}{k} {\sum }_{i = 1}^{k} {ℰ}_{{P}_{1}} ( {h}_{( i )}^{*} ) + {{c}^{′} ( \frac{VC ( H ) - log δ}{km} )}^{1 / ( 2 {ρ}_{max} ( k ) )}$$

where pₘₐₓ(k)=max {p₍₁₎, . . . , p₍ₖ₎} and c, c′ are constants.

We make a few important observations here. (i) The first term is the empirical risk on the chosen tasks and is typically small; in our experiments we achieve essentially zero training error on all sets of tasks. (ii) The second term grows with the number of chosen tasks k because we pick tasks that are more dissimilar to P₁. (iii) The third term typically decreases with k since we get more samples. These new samples are more and more inefficient because pₘₐₓ(k) increases with k. (iv) The second term can be made smaller by picking a larger hypothesis since space H which has more hypotheses that may match both Pᵢ and the desired task P₁. There is a trade-off here with the third term because we need commensurately more samples to select a hypothesis from a larger space. (v) It is expected that the minimum of the right-hand side is achieved at k<n and this optimal k is different for each desired target task. The ordering P₍₁₎, P₍₂₎, . . . is different for different desired tasks. This is an important point because it indicates that we should select an appropriate set of tasks to train each desired task with, and this set is different for each task. Excess risk on the desired task may deteriorate if competing tasks are trained together.

3 Model Zoo: Learning from Multiple Tasks Using an Ensemble of Models
Theorem 1 is a “no free lunch theorem” for multi-task learning. One should not always expect improved excess risk by combining data from different tasks. In particular, contrary to the motivation behind a number of studies in the current literature, training multiple tasks together is not just a challenge of optimization but a more fundamental question of representational capacity. We demonstrate a way to work around this theorem and next discuss Model Zoo that achieves (i) low generalization error on all tasks, not just low error on average, and (ii) that leverages data from other tasks, i.e., it improves excess risk as compared to training each task in isolation.

### 3.1 Model Zoo for Multi-Task Learning

We assume that P₁, . . . , Pₙ have the same input domain X but may have different output domains Y₁, . . . , Yₙ. Model Zoo is built iteratively by training upon a subset of tasks at each round. Let us take a simple example first. Training on a subset of two tasks, say P₁ and P₂, involves building a feature generator h and task-specific classifiers to obtain models g₁∘h:X→Y₂. This model can classify inputs from both tasks and gives out a probability vector p_{gi∘h}(y|x), ∀_{y} [symbol] Yᵢ depending upon the task. We assume that the identity of the task is known at test time. We do not so here by task-specific adapters f₁, f₂, to handle different input domains can also be learned similarly. At each round, we train on tasks P̅ₖ={P_{w}_{ₖ}_{¹}, . . . , P [symbol] } where [symbol] ≤n is a hyper-parameter and wⁱₖ [symbol] {1, . . . , n}. This involves training a feature generator hₖ and task-specific classifiers g_{k,l}∘hₖ. These models together form the “Model Zoo”. After k rounds, data from, say Pᵢ, can be predicted using the average of class probabilities output by all models in the zoo that were fitted on that task, i.e.,

p_{k,i}(y|x)∝Σᵢ₌₁^{k}1_{{P}_{ᵢ}_{∈P̅}_{ₖ}_{}}g_{k,i}∘hₖ(x)

### Selecting Tasks for Each Round Using Boosting

We should be careful in selecting the set of tasks P̅ₖ at each round. In principle, we could use the transfer exponents pᵢⱼ to select the tasks but computing them is essentially as difficult as training on all tasks. We would therefore like an automatic way to select tasks in each round. We draw inspiration from boosting for this purpose. Recall the popular AdaBoost algorithm which builds an ensemble of weak learners (they can be any learner in principle), each of which is fitted upon iteratively re-weighted training data. We think of the models learned at 4 each round of building the Model Zoo as “Weak learners”. Let w̅ₖ∈ [symbol] ⁿ be a normalized vector of task-specific weights. We set the weight w̅_{k,i} of each task Pᵢ after round k to

w̅_{k,i}∝exp(−1/mΣ_{(x,y)∈S}_{ᵢ} log p_{k,i}(y|x))

Tasks for the next round P̅ₖ₊₁ were drawn from a multinomial distribution with weights w̅ₖ; we initialize w̅₁ to be all 1s. Therefore, tasks with a low empirical risk under the current Model Zoo get a low weight for the next boosting round. Just like AdaBoost drives down the training error on all samples to zero exponentially by iteratively focusing upon difficult-to-classify samples, Model Zoo achieves a low empirical risk on all n tasks as more models are added to the ensemble.

### Some Intuition Behind the Model Zoo

The most important aspect of Model Zoo is that it eliminates competition between tasks by explicitly splitting the learner's capacity. Even if competing tasks are chosen in one particular round, which may result in high excess risk on a task in that round, tasks that have a high training loss under the ensemble will be chosen again in future rounds. This gives an intuitive understanding of the evolution of Model Zoo; dominant tasks which can be transferred to easily from many other tasks are fitted in early rounds.

Remark 2 (a Naïve Version of Model Zoo which Samples Tasks Randomly at Each Round).

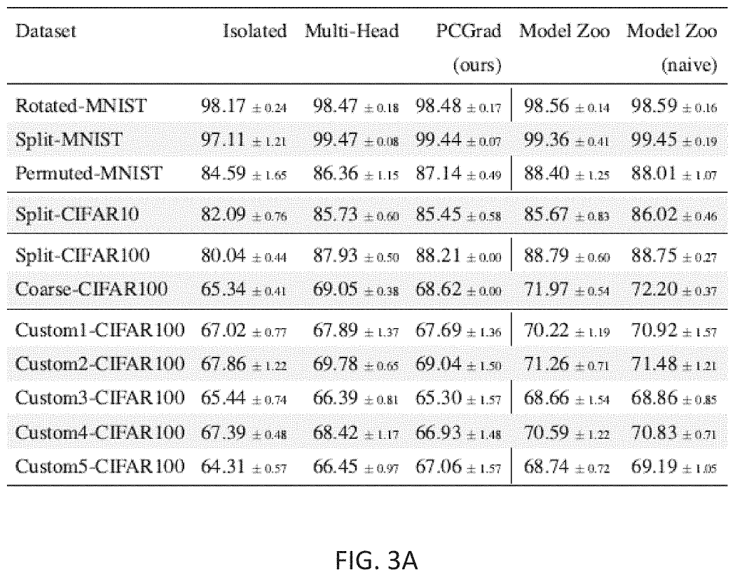

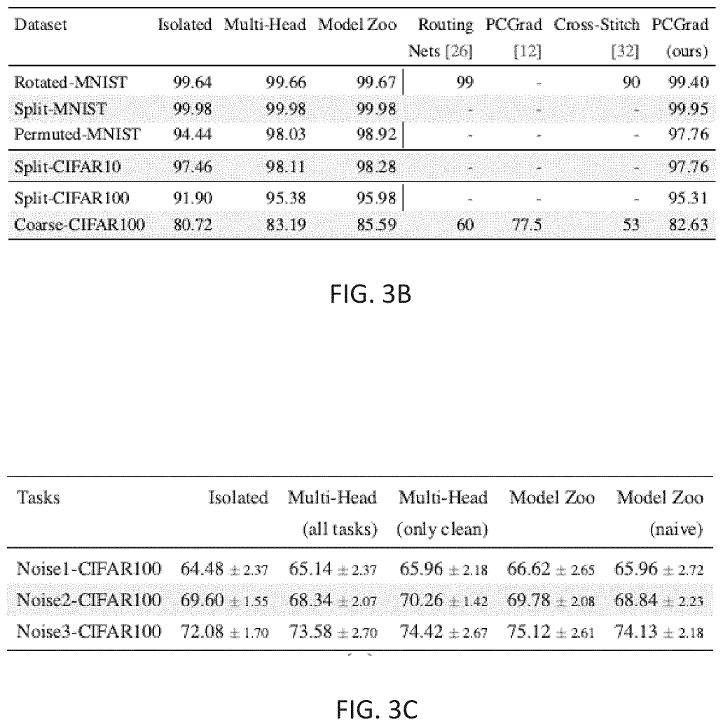

We can also sample tasks uniformly randomly at each round. This amounts to setting w̅_{k,i}∝1 for all rounds k and for all tasks l, and is akin to performing “stochastic gradient descent (SGD) on tasks” with the “mini-batch” Pₖ. This is a strong baseline and performs well in most cases because most sets of tasks in current benchmark datasets aid each other (see FIGS. 1B and 1C). Experiments in FIG. 3C show that adaptively picking tasks using (8) works better than this native version.

### Model Zoo for Continual Learning

Continual learning (often also called incremental or lifelong learning) has two main formulations. The first, called “sequential training”, trains a single model on a sequence of tasks P₍₁₎, . . . , P₍ₙ₎ without revisiting older tasks or increasing the capacity of the learner with time. As Theorem 1 discusses, doing so is fundamentally limiting in performance due to the competition between tasks. This is only made worse by catastrophic forgetting. Also, the prior learned from the particular sequence of tasks may be ill-suited to tackle future tasks (see the ordering in Theorem 1).

While we believe it is worthwhile to understand how to mitigate catastrophic forgetting and therefore study the strict formulation of continual learning, in this paper, we focus on a more pragmatic formulation. We will assume that the learner can revisit old tasks at any round of continual learning (also called episode) and is free to increase its learning capacity, in particular, by adding more models to the Model Zoo. Let P̅₍ₖ₎={(P₍₁₎, . . . , P₍ₖ₎} be the set of tasks accessible to the learner at round k. Task weights w̅ₖ are supported only on these k tasks now and the rest of setup from multi-task learning remains unchanged. Model Zoo is uniquely suited for continual learning because it maintains models from previous rounds that are not updated in successive rounds.

### Remark 3 (Diverse Datasets and Architectures can be Added to the Model Zoo).

In contrast to most current methods for multi-task and continual learning that share weights, or compute exemplar samples from past tasks, Model Zoo is completely agnostic to the architecture of the learner that is fitted at each round or the details of the inputs for each task. This is a key practical benefit because we can combine diverse architectures, including non-deep learning-based ones such as random forests for tabular data, into the same zoo without any changes to the formulation.

### Experiments

The goal of this section is to (i) evaluate the performance of Model Zoo on multi-task and continual learning benchmarks, (ii) develop a challenging suite of benchmarks by selecting diverse competing and non-competing tasks, and (iii) perform an ablation analysis of Model Zoo.

### Setup

We evaluate on Rotated-MNIST, Split-MNIST, Permuted-MNIST, Split-CIFAR10, Split-CIFAR100, and Coarse-CIFAR100. Split-MNIST, Split-CIFAR10 and Split-CIFAR100 use consecutive groups of labels to form tasks (2, 2, and 5 respectively for these three). Coarse-CIFAR100 is a variant of CIFAR100 where each super-class is considered a different task. Different papers use a different, random, grouping of labels as tasks for iCIFAR100; we found it quite difficult to ascertain their ordering and do not evaluate on this dataset. We use a small wide residual network (WRN-16-4 with only 3.6M weights) with task-specific classifiers (one fully-connected layer) for all experiments. Stochastic gradient descent (SGD) with Nesterov's momentum, cosine-annealed learning rate is used to train all models in mixed-precision. Ray Tune is used for hyper-parameter tuning. For all datasets, Model Zoo samples [symbol] =[n/2] tasks at each round and is run for [n/2] rounds. All hyper-parameters are kept fixed for all datasets.

### 4.1 Evaluating Multi-Task and Continual Learning Performance

We consider the following baselines to compare the performance of Model Zoo.
(i) Isolated trains are one model for each task in isolation. This does not leverage from other tasks but often outperforms existing methods.
(ii) Multi-Head trains one model with task-specific classifiers on all tasks together using SGD to minimize the average empirical risk; mini-batches contain samples from many different tasks. This suffers from competition between tasks but we find that this method also outperforms existing multi-task learning methods. Since Multi-Head is trained on all tasks together, it is a good upper bound on the accuracy of continual learning methods.
(iii) Model Zoo (naïve) samples [symbol] tasks uniformly randomly at each round of boosting. It is run for the same number of rounds as Model Zoo, and all other details of the training process are identical. This helps evaluate the specifics of the task sampling mechanism in Model Zoo.
(iv) PCGrad, which we implemented with a WRN-16-4 model (without routing). This achieves much high accuracies.
(v) For continual learning, in addition to Isolated, Multi-Head and Model Zoo (naïve) which we consider as baselines, we also compare against a large number of existing methods.
   All algorithms are compared in terms of the validation accuracy averaged across all tasks. We also consider situations when algorithms have access to fewer samples per class (also see FIGS. 1B and 1C).
   We construct a challenging set of problems for multi-task and continual learning using the Coarse-CIFAR100 dataset and the pairwise relative accuracies in FIGS. 1B and 1C. We sample 11 difficult problems (each problem consists of 4-7 tasks). These problems are referred to as Custom*-CIFAR100 in the sequel. These problems are indeed difficult: we find that the Multi-Head performs about as well as Isolated (FIG. 3A). We also created a separate set of problems named Noise*-CIFAR100 from Coarse-CIFAR100 which consists of randomly permuted labels for half the tasks (out of 4-10 total tasks). The idea is to have noisy tasks which consume the learning capacity of the model but may not help with transfer.

### Multi-Task Learning

We evaluate Model Zoo on multi-task learning in two situations, with 100 samples/class (FIG. 3a) and with access to all samples (FIG. 3b). Model Zoo uniformly outperforms all competing methods. Performance of Multi-Head, PCGrad (ours) and both variants of Model Zoo is similar for Routated-MNIST, Split-MNIST and Permuted-MNIST; these are known to be poor benchmarks and there is little competition between tasks here. Model Zoo and its naïve variant significantly outperform other methods on all other problems, in particular on the challenging Custom*-CIFAR100 problems that we created. This shows that splitting the capacity of the model to tackle task competition is effective for multi-task learning. Isolated and Multi-Head, which are both simple baseline algorithms perform strongly (FIG. 3A), and are often better than state-of-the-art methods such as Routing Nets, PCGrad, and Cross-Stitch (FIG. 3B). This indicates that we should interpret results using these complex methods in the literature critically. Further, having access to large number of samples/class on existing datasets is sufficient to obtain high accuracies without even leveraging data from other tasks; see FIG. 3B. This indicates that if we are evaluating on these datasets, we should use fewer samples per class.

### Continual Learning

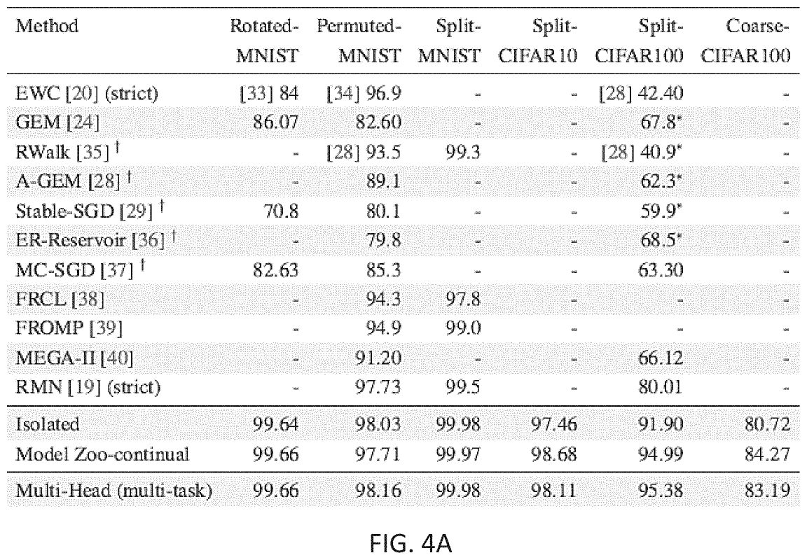

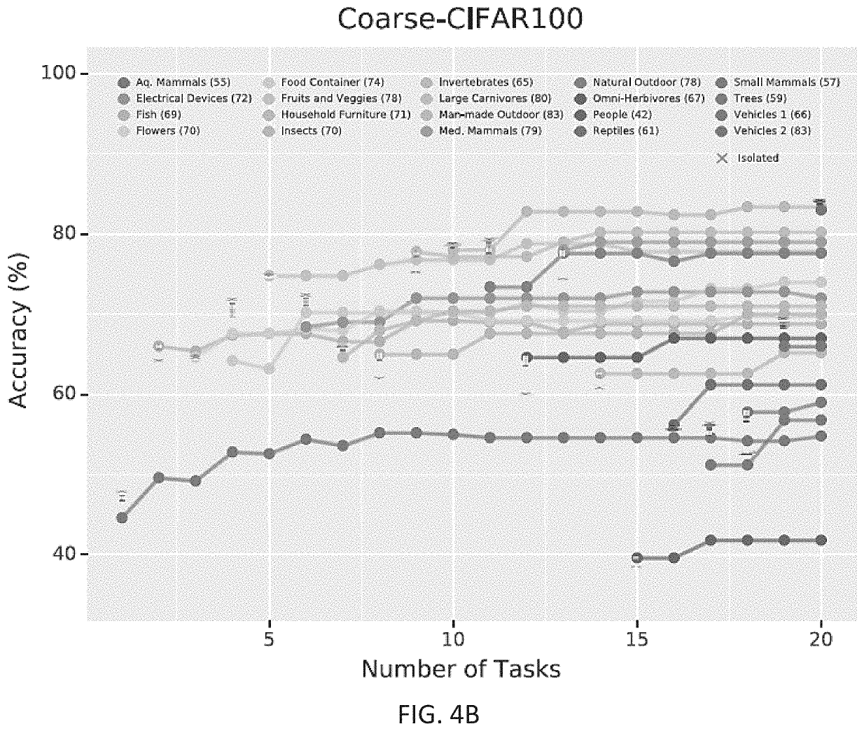

In order to evaluate Model Zoo on continual learning, as described above, a new task is introduced at each round of boosting (also called episode in continual learning) and task-weights w̅_{k,i} are restricted to tasks that have been observed. We sample min( [symbol] , k) tasks in round k. Per-task accuracy of all current algorithms in FIG. 4a is much poorer than Isolated (no continual learning). This indicates that all existing algorithms fail to achieve even a small amount of forward or backward transfer, i.e. how much do previous tasks aid the learning of a future task (compared to Isolated), and how much do future tasks benefit accuracy on a past task, respectively.

This is quite surprising. In comparison, Model Zoo outperforms all methods, including Isolated, by significant margins. FIG. 4B observes strong forward and backward transfer on Coarse-CIFAR100. Conceptually, the last row in FIG. 4A for a non-continually trained Multi-Head is akin to an upper bound on the accuracy of a continual learner. Model Zoo matches this accuracy, and it even performs better on the harder Coarse-CIFAR100 problem. This is a direct demonstration of how Model Zoo has a simple, but effective capacity splitting mechanism that can avoid catastrophic forgetting and yet leverage data from future tasks (some synergistic, some competing) even if tasks are shown sequentially. As far as we know, this ability is unlike any other method for continual learning in the literature.

### Analysis

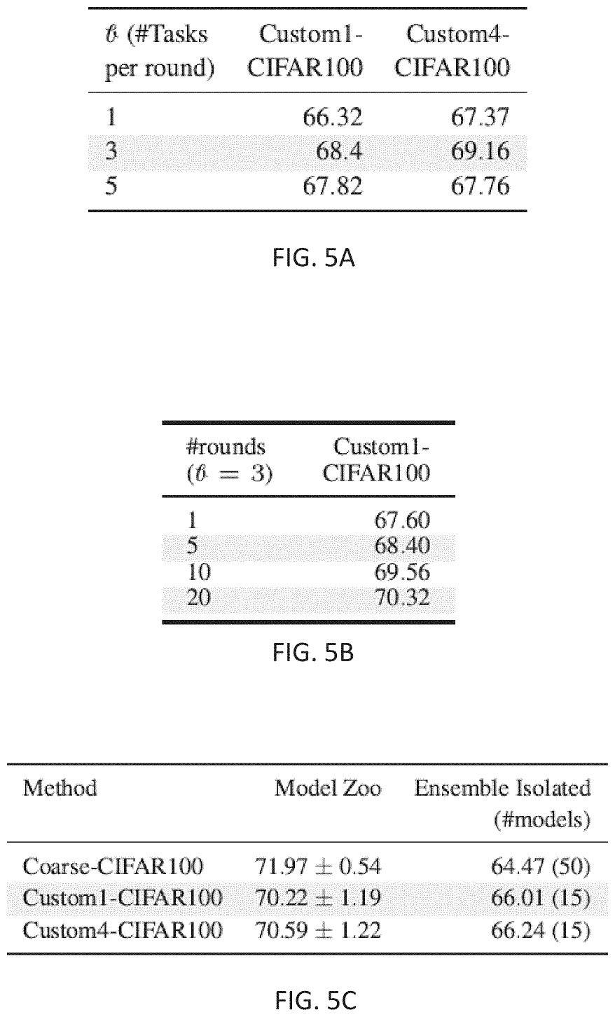

Ensembling does not match the performance of Model Zoo. En ensemble of Isolated learners is much worse than Model Zoo in FIG. 5C; we set the size of the ensemble here to match the effective number of models per task for the corresponding Model Zoo. Similarly, the accuracy of an ensemble of 5 Multi-Head learners (this is the same as the entry with 5 tasks per round in FIG. 5A) is also lower. This suggests that the performance of Model Zoo does not come from mere ensembling; the fact that different sets of tasks are chosen at different rounds is also important. Simply increasing the number of tasks per round is also not beneficial. As FIG. 5A shows, the accuracy of the Model Zoo drops if competing tasks are added. For our Custom*CIFAR100 problems, the sweet-spot seems to be 3 tasks/round.

Comparison with Large Models

Multi-Head with a large WRN-28-10 model (32M weights, about 2× more than Model Zoo with 5 rounds) does not work better than Model Zoo. In fact, its accuracy is about the same as that of Multi-Head with WRN-16-4. This suggests that performance of the Model Zoo does not arise from simply having more weights. Also, since the accuracy of Model Zoo improves with more rounds (FIG. 5B), what matters more is how the learning capacity in the zoo is split across sets of tasks. It may be difficult to replicate this capacity splitting mechanism using monolithic models that are trained on all tasks.

Model Zoo can ignore noisy capacity-hogging tasks from Noise*-CIFAR100 benchmark problems in FIG. 3C. Multi-Head trained on non-noisy tasks performs slightly better than Multi-Head trained on all tasks. Model Zoo improves upon the accuracy of both of these slightly. This indicates that while gradient conflicts may be an issue while training a single model, the boosting mechanism in the Model Zoo is an effective way to address it. This ability is valuable in practice because it is difficult to control the quality of data being fed into a continual learning system.

### Understanding the Performance of Model Zoo (Naïve)

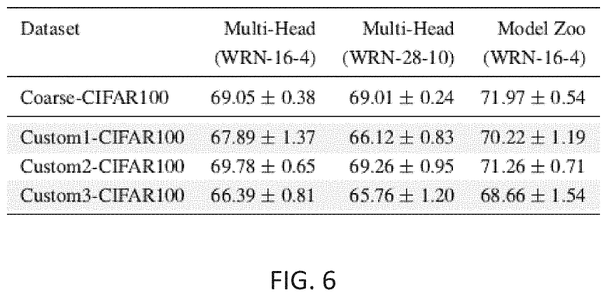

The only difference between Model Zoo and Model Zoo (naïve) is that the former samples tasks in each round using weights (8) instead of uniformly randomly. FIG. 3C shows that this is useful when there are some capacity-hogging noisy tasks that should be ignored. The two methods are comparable for other problems (FIGS. 3A and 3B) while both are much better than a large Multi-Head model (FIG. 3A vs. FIG. 6). This shows that the capacity splitting mechanism in Model Zoo and Model Zoo (naïve) is the key driver of empirical performance and not the details of boosting.

### Discussion

It is broadly appreciated that some tasks are synergistic and aid each other's learning while some others may result in deterioration of performance. However, it is unclear how one may work around this issue. The fundamental idea behind Model Zoo is that we need to grow the capacity of the learner in order to assimilate new, potentially competing, tasks. This requirement is at odds with the statistical wisdom that we need proportionally more data to fit a larger model, and this is why Model Zoo samples underperforming sets of tasks and fits a small model on them at each round. This idea is inspired from boosting and it provides a natural and elegant way to implement a number of existing techniques in the literature, e.g., soft/hard parameter sharing, progressively growing the model, freezing or consolidation of weights on old tasks, etc. We believe our perspective, although seemingly simple in hindsight, is powerful and our strong empirical results across the board substantiate its utility. Our work sheds light on the relevance of existing benchmarks for learning from multiple tasks. If simply training a model independently on each task works as well as sophisticated state-of-the-art methods, we definitely need to re evaluate the status quo.

Model Zoo: A Growing Brain that Learns Continuously

### Introduction

A continual learner seeks to leverage data from past tasks to learn new tasks shown to it in the future, and in turn, leverage data from these new tasks to improve its accuracy on past tasks. It stands to reason that the performance of such a learner would depend upon the relatedness of these tasks. If the two sets of tasks are dissimilar, learning on past tasks is unlikely to benefit future tasks—it may even be detrimental. And similarly, new tasks may cause the learner to “forget” and result in deteriorated accuracy on past tasks. Our goal in this paper is to model the relatedness between tasks and develop new methods for continual learning that result in good forward-backward transfer by accounting for such similarities and dissimilarities between tasks. Our contributions are as follows.

### 1. Theoretical Analysis

We characterize when multiple tasks can be learned using a single model and, likewise, when doing so is detrimental to the accuracy of a particular task. The key technical idea here is to define a notion of relatedness between tasks. We first show how if the inputs of different tasks are “simple” transformations of each other (and likewise for the outputs), then one can learn a shared feature generator that generalizes better on every task compared to training that task in isolation. Such tasks are strongly related and therefore it is beneficial to fit a single model on all of them. We show that if tasks are not so strongly related, in particular if the optimal model for one task predicts poorly on another task, then fitting a single model on such tasks may be worse than training each task in isolation. Such tasks compete with each other for the fixed capacity in the single model. We also use the CIFAR-100 dataset to empirically study this competition.

### 2. Algorithm Development

The above analysis suggests that a continual learner could benefit from splitting its learning capacity across sets of synergistic tasks. We develop such a continual learner called Model Zoo. At each episode, a small multi-task model that is fitted to the current task and some of the past tasks is added to Model Zoo. This method is loosely inspired from AdaBoost in that it selects tasks that performed poorly in the past rounds and could therefore benefit the most from being trained on the current task. At inference time, given the task, we average predictions from all models in the ensemble that were trained on that task.

### 3. Empirical Results

We comprehensively evaluate Model Zoo on existing continual learning benchmark problems and show comparisons with existing methods. There is an exceptionally wide variety in the problem settings used by existing methods, e.g., some replay data from past tasks (like Model Zoo is designed to do), some replay only a subset of data, some train only for one epoch in each episode, some use extremely small architectures, etc. We conduct systematic comparisons of Model Zoo in all these settings. We find that in all these settings, Model Zoo obtains dramatically better accuracy than existing methods (improvement in average per-task accuracy is as large as 30% on Split-minilmagenet). We show that Model Zoo demonstrates strong forward and backward transfer.

### 4. A Critical Look at Continual Learning

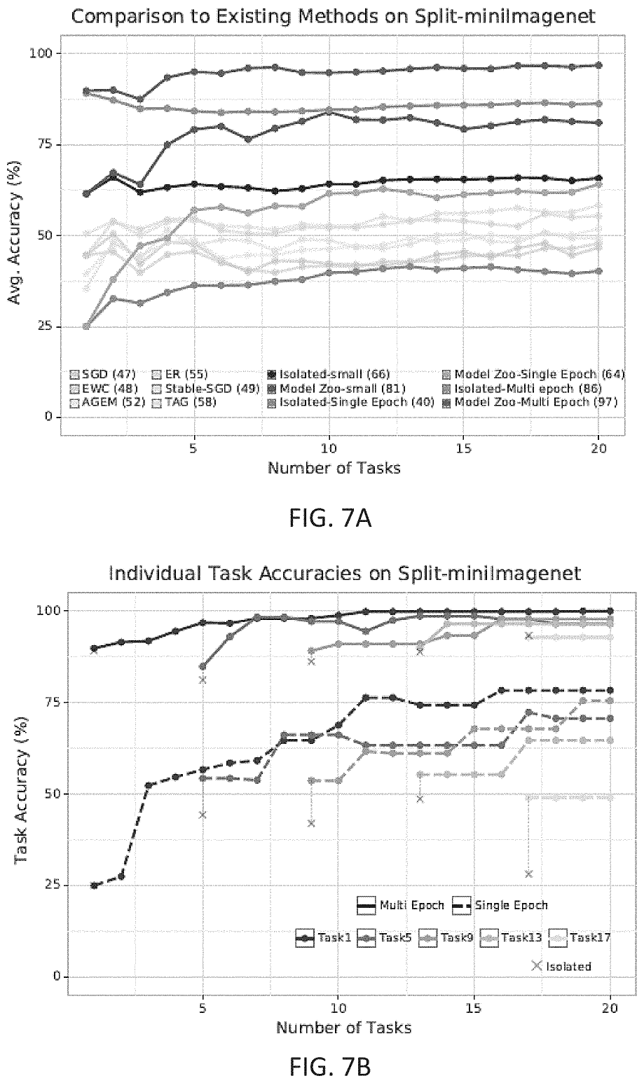

We find that even an Isolated learner, i.e., one which trains a (small) model on tasks from each episode and does not perform any continual learning, significantly outperforms all existing continual learning methods on all benchmark problems, e.g., by more than 8% in FIG. 7. This exceedingly simple learner has better training/inference time, does not perform any replay, and has a comparable number of weights as that of existing methods. This is surprising and points to a large intellectual gap in the current literature: while a number of existing methods seek to mitigate catastrophic forgetting, they often do so at the cost of forward or backward transfer. We advocate taking a step back and rethinking whether stylistic formulations are holding us back from building good continual learning methods. We advocate that per-task accuracy and forward-backward transfer should be the focus of future research.
A Theoretical Analysis of how to Learn from Multiple Tasks
In this section, we (i) formulate the problem of learning from multiple tasks, (ii) discuss a simple model that highlights when training one model on multiple tasks is beneficial, and (iii) show new results on how the fixed capacity of the model causes competition between tasks.

### Problem Formulation

A supervised learning task is defined as a joint probability distribution P(x, [symbol] ) of inputs x∈X and labels [symbol] ∈Y. The learner has access to m i.i.d samples S={xᵢ, [symbol] ᵢ}_{i=1, . . . ,m} from the task. A hypothesis is a function h:X→Y being the hypothesis space. The learner may select a hypothesis that minimizes the empirical risk

$${\hat{e}}_{𝒮} ( h ) = \frac{1}{m} {\sum }_{i = 1}^{m} {1}_{\{ h ( {x}_{i} ) \neq {y}_{i} \}}$$

with the hope of achieving a small population risk e_{P}(h)= [symbol] (h(x)≠y). Classical PAC-learning results suggest that with probability at least 1−δ over draws of the data S, uniformly for any h∈H, we have e̅_̅{̅P̅}̅(h)≤ê_{S}(h)+∈ if

m= [symbol] ((D−log δ)/∈²)

where D=VC(H) is the VC-dimension of the hypothesis space H. We define the “excess risk” of a hypothesis as ε_{P}(h)=e_{P}(h)−inf_{h∈H}e_{P}(h). In the continual learning setting, a new task is shown to the learner at each episode (or round). Hence after n episodes, the learner is presented with n tasks P̅:=(P₁, . . . , Pₙ), with the corresponding training sets S̅:=(S₁, . . . , Sₙ), each with m samples, and the learner selects n hypotheses h̅=(h₁, . . . , hₙ)∈Hⁿ each hᵢ∈H. If it seeks a small average population risk

$${e}_{P} ( \overline{h} ) = \frac{1}{n} {\sum }_{i = 1}^{n} {e}_{{P}_{i}} ( {h}_{i} ) ,$$

it may do so by minimizing the average empirical risk

$${\hat{e}}_{\overline{𝒮}} ( \overline{h} ) = \frac{1}{n} {\sum }_{i = 1}^{n} {\hat{e}}_{{𝒮}_{i}} ( {h}_{i} )$$

Under very general conditions, if

m= [symbol] (ε⁻²(d_{H}(n)−1/n log δ)),

then we have e_{P̅}(h̅)≤e_{S̅}(h̅)+∈ for any h̅∈Hⁿ. The quantity d_{H}(n) here is a generalized VC-dimension for the family of hypothesis spaces Hⁿ, which depends on the joint distribution of tasks. Larger the number of tasks n, smaller the d_{H}(n). Whether this is an improvement upon training the task in isolation depends upon the hypothesis class H and the relatedness of tasks P₁, . . . , Pₙ through the quantity d_{H}(n). The most important thing to note here is that according to these calculations, if one wishes to obtain a small average population risk across tasks, training multiple tasks together cannot be worse:

d_{H}(n)≤VC(H).

### Controlling the Excess Risk of a Specific Task for Synergistic Tasks

An important goal of continual learning is to have low risk on all tasks. This is a stronger requirement than given above which bounds the average population risk on all tasks.

Suppose there exists a family F of functions ƒᵢ:X→X that map the inputs of one task to those of another, i.e., any task can be written as

Pⱼ(A)=ƒ[Pᵢ](A)= [symbol] ᵢ({(ƒ(x), [symbol] ):(x, [symbol] ∈A})

for some function ƒ∈F for any set A. We can assume without loss of generality that F acts as a group over the hypothesis space and H is closed under its action. In simple words, this entails that given h∈H suitable for task P, we can obtain a new hypothesis h∘ƒ that is suitable for another task f[P]. Instead of searching over the entire space Hⁿ, we now only need to find a hypothesis h∈H such that its orbit

[h]_{F}={h′:∃ƒ∈F with h′=h∘ƒ}

contains hypotheses that have low empirical risk on each of the n tasks. Conceptually, this step learns the inductive bias. The sample complexity of doing so is given above. From within this orbit, we can select a hypothesis that has low empirical risk for a chosen task P₁. The sample complexity of this second step is

|S₁|= [symbol] (∈⁻²(dₘₐₓ−log δ))

where dₘₐₓ=sup_{h∈H}VC([h]_{F}). By uniform convergence, this two-step procedure assures low excess risk for every task P₁, . . . , Pₙ. We have

sup_{h∈H}VC([h]_{F})=dₘₐₓ≤d_{H}(n+1)≤d_{H}(n)≤D=VC(H)

The total sample complexity is favorable to that of learning the task in isolation if both d_{H}(n) and dₘₐₓ are small. For instance, if F is finite and n/log n≥D, we have d_{H}(n)≤2 log|F| which indicates that we get a statistical benefit of learning with multiple tasks if D>>log|F|.

Remark 1 (Data from Other Tasks May not Improve Accuracy Even if they are Synergistic).

Let us make a few observations using the above analysis. (i) From (4), number of samples per task m decreases with n; this is the benefit of the strong relatedness among tasks and as we see next, this is not the case in general. (ii) The number of tasks scales essentially linearly with D, which indicates that one should use a small model if we have few tasks. (iii) But we cannot always use a small model. If tasks are diverse and related by complex transformations with a large |F|, we need a large hypothesis space to learn them together. If |F| is large and H is not appropriately so, the VC-dimension dₘₐₓ is as large as D itself; in this case there is again no statistical benefit of training with multiple tasks together, but there is no deterioration either.

Task Competition Occurs for Hypothesis Spaces with Limited Capacity

There could be settings under which fitting one model on multiple tasks may not suffice. To study this, we consider a weaker notion of relatedness. We say that two tasks Pᵢ, Pⱼ are ρᵢⱼ, related if

cε_{P}_{ᵢ}^{1/ρ}^{ᵢⱼ}(h)≥ε_{P}_{₁}(h,h*ᵢ), for all h∈H.

Here ε_{P}(h,h′):=e_{P}(h)−e_{P}(h′) and h*ᵢ=argmin_{h∈H}e_{P}_{ᵢ}(h) is the best hypothesis for task Pᵢ; we set c≥1 to be a coefficient independent of i,j. Smaller the ρᵢⱼ, more useful the samples from Pᵢ to learn Pⱼ. The definition suggests that all hypotheses h which have low excess risk on Pᵢ also have low excess risk on Pⱼ up to an additive term e_{P}_{ⱼ}(h*) and this effect becomes stronger as ρᵢⱼ→1+. Note that the definition of relatedness is not symmetric. To gain some intuition, we can connect this definition to a certain triangle inequality between tasks: in the realizable setting where e_{P}_{ᵢ}(h*ᵢ)=0, for c,ρᵢⱼ=1, we can write

e_{P}_{ᵢ}=(h)+e_{P}_{ⱼ}(h*ᵢ)≥e_{P}_{ⱼ}(h)

which is akin to a triangle with vertices at h, h*ᵢ and h*ⱼ with terms like e_{P}_{ᵢ}(h) representing the length of the side between h and h*ᵢ. This definition therefore models a set of tasks and hypothesis space that is not unduly pathological, e_{P}_{ⱼ}(h) cannot be much worse than the sum of the other two sides. We can now show the following theorem bounds the excess risk ε_{P}_{ᵢ}(h) for a hypothesis h trained using data from multiple tasks.

### Theorem 2 (Task Competition).

Say we wish to find a good hypothesis for task P1 and have access to n tasks P₁, . . . , Pₙ where each pair Pᵢ, Pⱼ are ρᵢⱼ related. Arrange tasks in an increasing order of ρᵢ₁ i.e., their relatedness to P₁. Let this ordering be P₍₁₎, P₍₂₎, . . . , P₍ₙ₎. Let ĥ^{k} be the hypothesis that minimizes the average empirical risk of the first k≤n tasks. Then, with probability at least 1−δ over draws of the training data,

$${ℰ}_{{P}_{1}} ( {\hat{h}}^{k} ) \leq \frac{1}{k} {\sum }_{i = 1}^{k} {ℰ}_{{P}_{1}} ( {h}_{( i )}^{*} ) + \frac{c}{k} {( {e}_{\overline{𝒮}} ( h ) + {{c}^{′} ( \frac{D - log δ}{k m} )}^{1 / 2} )}^{1 / {ρ}_{max}}$$

where ρₘₐₓ(k)=max {ρ₍₁₎, . . . , ρ₍ₖ₎} and c,c′ are constants.

Notice that the first term grows with the number of tasks k because we pick tasks with lower ρᵢ₁ that are more and more dissimilar to P₁. The second term typically decreases with k. The empirical risk e_{S̅}(h) is typically small; in our experiments with deep networks we achieve essentially zero training error on all. Increasing the number of tasks k, increases the effective number of samples km, thereby reducing the second term in totality. At the same time, these new samples are increasingly more inefficient because ρₘₐₓ(k) increases with k.

### Remark 3 (Picking the Size of the Hypothesis Space).

The first and second terms characterize synergies and competition between tasks and balancing them is the key to good performance on a given task. Increasing the size of the hypothesis space reduces the first term since it allows a single hypothesis to more easily agree on two distinct distributions Pᵢ and Pⱼ. However, this comes at the cost of increasing the second term which grows with the size of the hypothesis space.

### Remark 4 (the Set of Synergistic Tasks can be Different for Different Tasks).

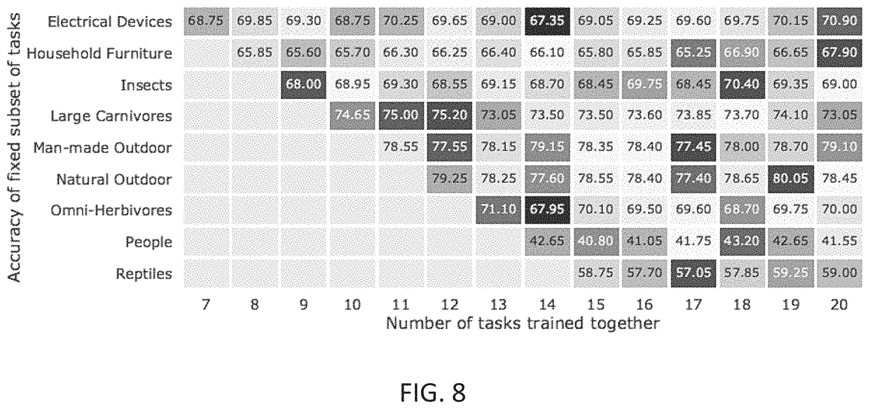

The right hand side is minimized for a choice of k (where 1≤k≤n) that balances the first and second terms. The optimal k can vary with the task, e.g., for generic tasks most other tasks will be synergistic and similarly a small optimal k indicates task dissonance where the particular task, say P₁ should be trained on with a specific set of other tasks. Even for typical datasets like CIFAR-100, it is highly nontrivial to understand the ideal set of tasks to train with; FIG. 8 studies this experimentally.

### Remark 5 (Continual Learning is Particularly Challenging Due to Task Competition).

Theorem 2 indicates that not only is the learner shown tasks sequentially, but it also may have to work against the competition between the current task and the representation learned on a past task. It does not have access to synergistic tasks from the future while learning on the current task. And further, in settings where there is no data replay, the learner cannot benefit from past synergistic tasks explicitly, other than the representation that it has already learnt. This suggests that one must be even more careful about how the representation in continual learning should be updated.
Model Zoo: A Continual Learner that Grows its Learning Capacity

Theorem 2 can be thought of as a “no free lunch theorem”. It indicates that ones should not always expect improved excess risk by combining data from different tasks. This theorem also suggests a way to work around the problem via Remarks 3 and 4. If we learn small models on synergistic tasks, we can hope to have each task benefit from the synergies without deterioration of accuracy due to task competition with dissonant tasks. Model Zoo is a simple method that is designed for this purpose.

Let us assume that tasks P₁, . . . , Pₙ are shown sequentially to the continual learner. We assume that all tasks have the same input domain X but may have different output domains Y₁, . . . , Yₙ. At each “episode” k, Model Zoo is designed to train using the current task Pₖ and a subset of the past tasks. For example, at episode k=2, we train a model with a feature generator h and task-specific classifiers to obtain models g₁∘h:X [symbol] Y₁ and g₂∘h:X [symbol] Y₂. This model can classify inputs from both tasks and gives out a probability vector P_{g∘h}( [symbol] |x), [symbol] ∈Yᵢ depending upon the task. We assume that the identity of the task is known at the test time (task-incremental learning).

Let the set of tasks considered at episode k be denoted by P̅ₖ={P_{w}_{ₖ}_{¹}, . . . , P [symbol] } where [symbol] ≤k is a hyper-parameter and wₖⁱ∈{1, . . . , k}. Training on P̅ₖ will involve, like the example above, training one model with a feature generator hₖ and task-specific classifiers q_{k,w}_{ₖ}_{ⁱ} for each task selected in that round. Such models, one trained in each round, together form the “Model Zoo”. After k rounds, data from, say, Pᵢ can be predicted using the average of class probabilities output by all models that were fitted on that task, i.e.,

p_{k,i}(y|x)∝Σₗ₌₁^{k}1_{{P}_{ᵢ}_{∈P}_{ₗ}_{}}g_{l,i}∘hₗ(x)

This expression is also used to predict at test time. Selecting tasks to train with for each round using boosting In principle, we could use the transfer exponents ρᵢⱼ to select synergistic tasks, but computing the transfer exponents is essentially as difficult as training on all tasks, a continual learning does not have access to all tasks a priori. We therefore develop an automatic way to select tasks in each round. Recall the AdaBoost algorithm which builds an ensemble of weak learners (they can be any learner in principle), each of which is fitted upon iteratively re-weighted training data. We think of the models learned at each episode of continual learning in Model Zoo as the “weak learners” and each round of boosting as the equivalent of each episode of continual learning. Let w̅ₖ∈ [symbol] ⁿ be a normalized vector of task-specific weights. After episode k

w̅_{k,i}∝exp(−1/mΣ_{(x,y)∈S}_{ᵢ} log p_{k,i}( [symbol] |x))

for each task Pᵢ with i≤k; for i>k, w̅_{k,i}=0. Tasks for the next round P̅ₖ₊₁ are drawn from a multinomial distribution with weights w̅ₖ. Therefore, tasks with a low empirical risk under the current Model Zoo get a low weight for the next boosting round. Just like AdaBoost drives down the training error on all samples to zero exponentially by iteratively focusing upon difficult-to-classify samples, Model Zoo achieves a low empirical risk on all tasks as more models are added.
The key feature of Model Zoo is that it automatically splits the capacity across sets of tasks. Even if competing tasks are chosen in one round, which may result in high excess risk on some task, it will be chosen again in future rounds if it has a large error under the ensemble.

### Empirical Validation

### Setup

Datasets * We evaluate on Rotated-MNIST (Lopez-Paz and Ranzato, 2017), Split-MNIST (Zenke et al., 2017), Permuted-MNIST (Kirkpatrick et al., 2017), Split-CIFAR10 (Zenke et al., 2017), Split-CIFAR100 (Zenke et al., 2017), Coarse-CIFAR100 (Rosenbaum et al., 2017) and Splitminilmagenet (Vinyals et al., 2016; Chaudhry et al., 2019b). Split-MNIST, Split-CIFAR10, Split-CIFAR100 and Split-minilmagenet use consecutive groups of labels (2, 2, 5 and 10, respectively) to form tasks. Coarse-CIFAR100 is a variant of CIFAR100 where each super-class is considered a different task; this dataset has not been used for benchmarking in continual learning prior to our work. Our study in FIG. 8 has found that Coarse-CIFAR100 is a difficult dataset for continual learning, perhaps because of the semantic differences among the different super-classes.

### Neural Architectures and Training Methodology

We use a small wide-residual network of Zagoruyko and Komodakis (2016) (WRN-16-4 with 3.6M weights) with task-specific classifiers (one fully-connected layer). We also use an even smaller network (0.12M weights) with 3 convolution layers (kernel size 3 and 80 filters) interleaved with max-pooling, ReLU, batch-normlayers, with task-specific classifier layers. Stochastic gradient descent (SGD) with Nesterows momentum and cosine-annealed learning rate is used to train all models in mixed precision. Ray Tune (Liaw et al., 2018) was used for hyper-parameter tuning using a multi task learning model on all tasks from Coarse CIFAR-100. When we do full replay, Model Zoo samples b=min(k; 5) tasks at the kth episode; for problems with n=5 tasks, we set b=2; note that b=1 indicates no data replay. All hyper-parameters are kept fixed for all datasets and all experiments.

Evaluating Continual Learning Methods

There is a wide variety of problem formulations in the continual learning literature (Farquhar and Gal, 2019a; Prabhu et al., 2020; Vogelstein et al., 2020; Lopez-Paz and Ranzato, 2017; Van de Ven and Tolias, 2019). Formulations vary with respect to whether they allow replaying data from past tasks, the number of epochs the learner is allowed to train each task for, and the capacity of the model being fitted. We next explain these different formulations, the rationale behind them, and how we execute Model Zoo to conform to each of these settings.
(i) The strict formulation does not allow any replay of data. For the strict formulation of Model Zoo, we simply set w̅_{k,i}0 for all i≠k. At each episode, a single model is trained on the current task and added to the zoo—we call this rather simplistic learner Isolated. From a practical standpoint, such a formulation imposes a constraint on the amount of computational resources (compute and/or memory) available during training.
(ii) One can replay data to various degrees, e.g., all of it, or a subset of it. Just like AdaBoost, Model Zoo is fundamentally designed to allow full replay of past tasks. However, we can easily execute it with limited replay by only using a subset of the data to compute gradient updates and the accuracy on past tasks in episode kth. We use the nomenclature Model Zoo (10% replay) to indicate that only 10% of the data from past tasks is used; algorithms like A-GEM (Chaudhry et al., 2019a) also use 10% of past data on CIFAR100 datasets. Note that Model Zoo without any data replay is simply Isolated. Let us emphasize that across all these problem settings, Model Zoo remains a legitimate continual learner because it gets access to each task sequentially and has a fixed computational budget (b tasks) at each episode. For a multi-task learner, the computational complexity scales with the number of tasks.
(iii) To impose a strict constraint on the computational complexity of each episode some works train each task for a single epoch. We therefore show results using both Model Zoo (single epoch) (where we replay past data for 1 epoch) and Isolated (single epoch) (no replay). Even if the rationale behind using each datum only once is well-taken, one single epoch is quite insufficient to train modern deep networks; if one thinks of biological considerations, local-descent algorithms like stochastic gradient descent (SGD) are quite different from recurrent circuits in the biological brain. We also run single epoch methods using a very small model (0.12M weights); these are Model Zoo/isolated-small (single epoch).
(iv) Multi-Head trains one single model on all tasks to minimize the average empirical risk with task-specific classifiers; mini-batches contain samples from different tasks. Since Multi-Head is trained on all tasks together, it is not a continual learner, but its accuracy is expected to be an upper bound on the accuracy of continual learning methods.

Evaluation Criteria

We compare algorithms in terms of the validation accuracy averaged across all tasks at the end of all episodes, average per-task forward transfer (accuracy on a new task when it is first seen, larger this number more the forward transfer), average per-task forgetting (gap in the maximal accuracy of a task during continual learning and its accuracy at the end, larger this number more the forgetting and worse the backward transfer), training and inference time, and memory. Let us note that forward transfer is also sometimes call d “learning accuracy”, and another measure of backward transfer is the gap between the accuracy at the end of training and the initial accuracy of the task.

Results

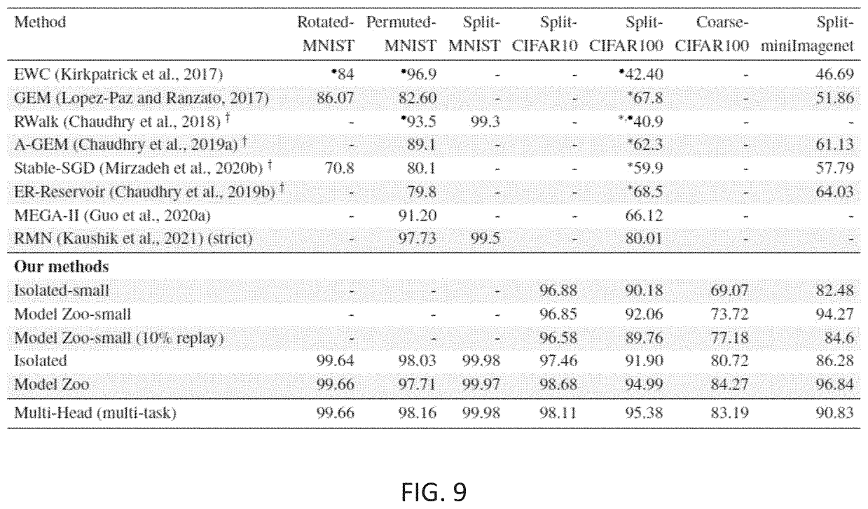

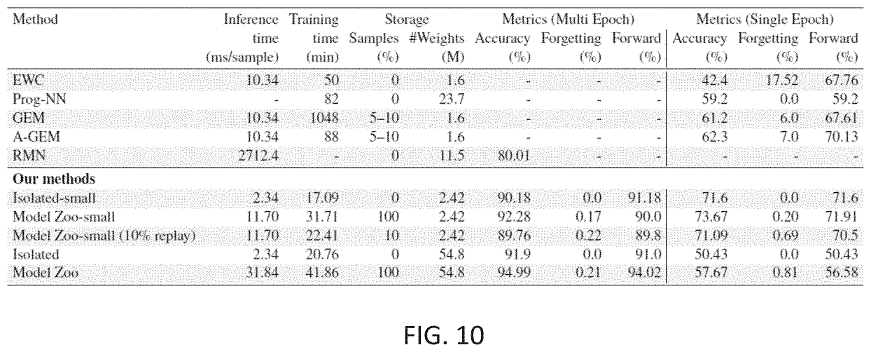

FIG. 9 shows the validation accuracy of different continual learning methods on standard benchmark problems. There are many striking observations here.
(i) Accuracy of all existing methods in FIG. 9, regardless of their specific setting, is much poorer than Isolated (more than 10% for both the small and standard versions). This is surprising because Isolated can be thought of as the simplest possible continual learner—one that unfreezes new capacity at each episode and does not replay data. This indicates that existing methods may be failing to achieve forward or backward transfer compared to simply training the task in isolation; FIG. 10 investigates this further.
(ii) In comparison, Model Zoo (all three variants: small, small with 10% data replay and the standard method) has dramatically better accuracy (more than 10% better than existing methods) both compared to existing methods as well as compared to Isolated. This shows the utility of splitting the capacity of the learner across multiple tasks.
(iii) Model Zoo matches the accuracy of the multi-task learner in the last row of FIG. 9 which has access to all tasks beforehand. Surprisingly, Model Zoo performs better than Multi-Head in spite of being trained in continual fashion, especially on harder problems like Coarse-CIFAR100 and Split-minilmagenet. This is a direct demonstration of the effectiveness of Model Zoo in mitigating task competition: the capacity splitting mechanism not only avoids catastrophic forgetting, but it can also leverage data from other tasks even if they are shown sequentially.

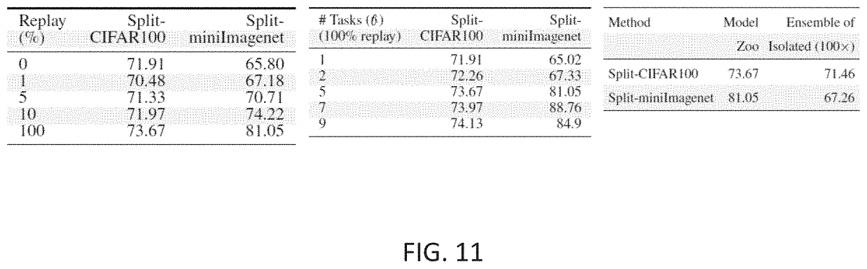

FIG. 10 shows a comparison of the methods developed in this paper with existing methods on Split-CIFAR100 in terms of continual-learning specific metrics. FIG. 11 shows ablation studies that show the average per-task accuracy as we vary the size of data replay for Model Zoo (left), the number of past tasks sampled at each episode (middle, [symbol] =1 implies no replay), and compare Model Zoo with an ensemble of Isolated models (right). These results are for the single-epoch setting. We find:
(i) There are no significant differences in the forward transfer performance in the single epoch setting;
larger variants of Isolated and Model Zoo do not work well here because a single epoch is not sufficient to train modern deep networks. But Model Zoo and variants show dramatically less forgetting, it is essentially zero. This indicates that although existing methods are designed to avoid forgetting (the single epoch setting aids this directly), say, A-GEM, or EWC, they do forget. Forgetting can be mitigated by the capacity splitting mechanism in Model Zoo. The per-task accuracy of existing methods is also rather low compared to Model Zoo variants.
(ii) If our methods are implemented in the multi-epoch setting, then the forward transfer is exceptionally good and almost as good as the average accuracy of the task. Surprisingly, this does not come at the cost of forgetting, which is again essentially zero.
(iii) Even if Model Zoo and its variants are implemented with very small models (0.12M weights/episode, which is 2.42M weights/20 episodes), the accuracy is dramatically better (FIG. 9). This suggests that Model Zoo is a performant and viable approach to continual learning. In fact, even the larger model used in Model Zoo is a WRN-16-4 with 3.6M weights and therefore we can train multiple models on the same GPU easily; this is why the training time of Model Zoo is about the same as that of Model Zoo-small.
(iv) The simplicity of Model Zoo and its variants results in much smaller training times and comparable inference times as compared to existing methods.

### DISCUSSION

Continual learning is an important problem as deep learning systems transition from the traditional paradigm of having a fixed model that makes inferences on user queries to settings where we would like to update the model to handle new types of queries. The key desiderata of such a system are clear it must display high per-task accuracy and strong forward-backward transfer. This paper seeks to develop such a continual learner and investigates the problem using the lens of task relatedness. It argues that the learner must split its capacity across sets of tasks to mitigate competition between tasks and benefit from synergies among them. We develop Model Zoo, which is a continual learning algorithm inspired by AdaBoost, that grows an ensemble of models, each of which is trained on data from the current episode along with a subset of past tasks. We show that across a wide variety of datasets, problem formulations, and evaluation criteria, Model Zoo and its variants significantly outperform all existing continual learning methods.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for machine learning, the method comprising:
for each training round of a plurality of training rounds:
selecting a subset of computing tasks from a plurality of computing tasks;
building a feature generator for the subset of computing tasks; and
training a task-specific classifier for each computing task of the subset of computing tasks, resulting in a model for each computing task of the subset of computing tasks; and
performing, using at least some of the models for the computing tasks, one of the computing tasks.

2. The method of claim 1, wherein selecting the subset of computing tasks comprises maintaining a vector of task-specific weights and selecting the subset of computing tasks based on the task-specific weights.

3. The method of claim 2, wherein selecting the subset of computing tasks based on the task-specific weights comprises drawing the subset of computing tasks from a multinomial distribution of the task-specific weights.

4. The method of claim 1, further comprising revisiting at least a first computing task from the plurality of computing tasks by adding one or more new models.

5. The method of claim 4, further comprising maintaining one or more models from previous training rounds not updated in successive training rounds.

6. The method of claim 1, wherein each of the plurality of computing tasks shares a common input domain.

7. The method of claim 1, comprising learning at least one task-specific adapter for at least one computing task having a different input domain from at least one other computing task.

8. A system for machine learning, the system comprising:
at least one processor, and
a multi-task learner implemented on the at least one processor and configured to perform operations comprising:
for each training round of a plurality of training rounds:
selecting a subset of computing tasks from a plurality of computing tasks;
building a feature generator for the subset of computing tasks; and
training a task-specific classifier for each computing task of the subset of computing tasks, resulting in a model for each computing task of the subset of computing tasks; and
performing, using at least some of the models for the computing tasks, one of the computing tasks.

9. The system of claim 8, wherein selecting the subset of computing tasks comprises maintaining a vector of task-specific weights and selecting the subset of computing tasks based on the task-specific weights.

10. The system of claim 9, wherein selecting the subset of computing tasks based on the task-specific weights comprises drawing the subset of computing tasks from a multinomial distribution of the task-specific weights.

11. The system of claim 8, further comprising revisiting at least a first computing task from the plurality of computing tasks by adding one or more new models.

12. The system of claim 11, further comprising maintaining one or more models from previous training rounds not updated in successive training rounds.

13. The system of claim 8, wherein each of the plurality of computing tasks shares a common input domain.

14. The system of claim 8, comprising learning at least one task-specific adapter for at least one computing task having a different input domain from at least one other computing task.

15. A non-transitory computer readable medium storing executable instructions that when executed by at least one processor of a computer control the computer to perform operations comprising:
for each training round of a plurality of training rounds:
selecting a subset of computing tasks from a plurality of computing tasks;
building a feature generator for the subset of computing tasks; and
training a task-specific classifier for each computing task of the subset of computing tasks, resulting in a model for each computing task of the subset of computing tasks; and
performing, using at least some of the models for the computing tasks, one of the computing tasks.

16. The non-transitory computer readable medium of claim 15, wherein selecting the subset of computing tasks comprises maintaining a vector of task-specific weights and selecting the subset of computing tasks based on the task-specific weights.

17. The non-transitory computer readable medium of claim 16, wherein selecting the subset of computing tasks based on the task-specific weights comprises drawing the subset of computing tasks from a multinomial distribution of the task-specific weights.

18. The non-transitory computer readable medium of claim 15, the operations further comprising revisiting at least a first computing task from the plurality of computing tasks by adding one or more new models.

19. The non-transitory computer readable medium of claim 15, wherein each of the plurality of computing tasks shares a common input domain.

20. The non-transitory computer readable medium of claim 15, the operations further comprising learning at least one task-specific adapter for at least one computing task having a different input domain from at least one other computing task.
